(19) United States
(12) Patent Application Publication
(10) Pub. No.: US 2007/0069028 A1
(43) Pub. Date: Mar. 29, 2007

(54) System to improve reading performance and accuracy of single or two dimensional data codes in a large field of view

(76) Inventor: Yaron Nemet, Kedumim (IL)

Correspondence Address: GOODWIN PROCTER L.L.P, 599 LEXINGTON AVE., NEW YORK, NY, 10022, US

(21) Appl. No.: 11/298,119

(22) Filed: Dec. 9, 2005

Related U.S. Application Data
(60) Provisional application No. 60/634,870, filed on Dec. 10, 2004.

(51) Int. Cl. G06K 7/10; G06K 19/06

(52) U.S. Cl. 235/462.41; 235/462.09; 235/494

(57) ABSTRACT

A plural-component symbology is provided, which includes a substrate for displaying symbols thereon, and a locater and a data code symbol displayed on the substrate. The locater code symbol has first detectable elements to be read. The data code symbol has a fixed physical relationship to the locater code symbol and has second detectable elements to be read which are optically distinguishable from the first detectable elements. The first detectable elements can have a first size and the second detectable elements a second size which is smaller than the first size. A methodology for reading data relating to objects, at least some of which have at least one plural-component symbology affixed thereto, is also provided, and includes imaging the plurality of objects together, locating at least some of the objects, attempting to read data relating to the located objects, and further processing of any plural component symbologies.

### REFERENCE TO PROVISIONAL APPLICATION

This application is based on and claims the benefit of the filing date of provisional application Ser. No. 60/634,870 filed on Dec. 10, 2004 and entitled System To Improve Reading Performance and Accuracy of Single or Two Dimensional Data Codes in a Large Field of View, which is incorporated herein by reference.

### FIELD OF THE INVENTION

This invention relates to a plural component symbology and a method for reading the same in a large field of view.

### BACKGROUND OF THE INVENTION

One dimensional and two dimensional coding systems are used to store data to be optically read. They are commonly read by an imager based on a CCD or CMOS sensor and software (see for example U.S. Pat. No. 6,922,208 which is incorporated herein by reference). In order to read the code each and every element from the code should be transformed into pixels by the imager. Those pixels sensed by the software indicate the data stored. The number of pixels needed for reading one or two dimensional codes is determined by the imager resolution and quality, the field of view, the analyzer software and the sampling rules.

For example to read a single Data Matrix code size 10 by 10 detectable elements the code in the image will be required to acquire approx 35 by 35 pixels.

The use of high resolution imager combined with special software can read single or multiple two dimensional codes in a relatively large field of view.

For example: when using a 6 mega pixel imager with resolution of 3000 * 2000 pixels and the software requires 35 pixel by 35 pixels in order to read accurately a single data matrix in density 10×10 detectable elements, and the data matrix is 1 inch by 1 inch size the field of view may be more than (3000/35×1=) 85 inches by (2000/35×1=) 57 inches and the data matrix can still be successfully read (in this case the code part of the image will have 35×35 pixels).

Reading multiple codes in large Field of view enable reads of multiple objects grouped together such as boxes piled on a palate for track shipments (as described in U.S. Pat. No. 6,922,208) or for QA purpose (as described in my patent application Ser. No. 60/634,870 which was filed on Dec. 10, 2004) or any other need.

When dealing with a high number of codes per read the importance of accurate reading is crucial: if a handheld device for reading a single item is being used and achieves accuracy of 99% it may be good enough but when reading 100 boxes at a time in the field of view and the reader achieves 99% accuracy it may be that 100% of the reads have at least one error.

When dealing with a relatively large field of view one of the challenges of the software is to detect the locations of the codes. After DETECTING those locations the data is extracted by a DECODING phase.

The DETECTING phase uses common detectable elements and rules which are predefined and common for the code standard. The inherent detection parts of the code are usually used to help to determine the orientation and the exact location of a code in a small field of view when the code itself occupies a relatively large portion of the field of view.

In the DECODING phase the data is extracted from the code using a set of rules that apply to the changed information part of the codes.

When an image is being taken and analyzed by the DETECTION phase it may be that a relatively large number of false positive detections are being detected. Those false positive detections are being processed in further steps (at next steps of the DETECTION phase or by the DECODING phase) and some or all of them will be discarded after this time consuming process.

Because DETECTION is preliminary to DECODING the software should make sure that all the elements are being detected properly. Whenever there is doubt further processing should be done and more time and resources should be used for DETECTION.

In a case when a large field of view is being captured some of the codes may lack sufficient resolution or lack the required image quality required (because of lightening, shades, reflections etc.) in order to assure accurate reading. In those cases when the DECODING phase didn't succeed to read the codes those codes are considered as false detections and are discarded. In many cases the software can not distinguish between false detection of the code and misread codes.

The current invention is to create higher certainty in detecting the code first to eliminate false detection and thereby increase the performance of the DETECTION phase and the DECODING.

### BRIEF DESCRIPTION OF THE INVENTION

With these and other deficiencies of the prior art in view, one embodiment of the present invention relates to a plural-component symbology, comprising: a substrate for displaying symbols thereon; a locater code symbol displayed on said substrate; said locater code symbol having first detectable elements to be read; and a data code symbol displayed on said substrate; said data code symbol having second detectable elements to be read; said data code symbol having a fixed physical relationship to said locater code symbol; wherein said first detectable elements are optically distinguishable from said second detectable elements. In one embodiment, the detectable elements in said locater code symbol is larger than the data code symbol.

In another embodiment of the present invention the plural-component symbology data symbol is a two dimensional bar code symbol. The plural-component symbology can also have said data symbol as a Data Matrix bar code symbol.

In another embodiment of the present invention the plural-component symbology can have said first detectable elements of a different color then said second detectable elements.

In another embodiment of the present invention a methodology for reading data relating to objects is also provided. The methodology comprises receiving a plurality of objects, at least some of said plurality of objects having at least one of the plural-component symbologies as described above; imaging said plurality of objects together to provide an image of said plurality of objects including said plural-component symbologies; employing said image to locate said at least some of said plurality of objects; employing said image to attempt to read data relating to all of said at least some of said objects of said plurality of objects; and if said data is only determined about less than all of said at least some of said plurality of objects further processing some or all of said plural-component symbologies.

The methodology as described above can have said further processing as counting and indicating the number of said objects of said at least some of said plurality of objects and said data about said less than all of said at least some of said objects of said plurality of objects, reading partial data from the unread data; re imaging said plurality of objects together to provide a re image of said plurality of objects including said plural-component symbologies; employing said re image to locate said at least some of said plurality of objects; and employing said re image to attempt to read at least the unread data which can be done with greater resolution, with better lighting and/or with a PTZ camera assembly to capture a select portion of the plurality of objects with greater resolution.

The methodology as described two paragraphs above can have said imaging including the step of obtaining a beginning image in a first resolution and sampling said image in a first resolution to obtain said image; said further processing is obtaining said beginning image; employing said beginning image to locate said at least some of said plurality of objects; and employing said beginning image to attempt to read at least the unread data.

The present invention also includes the additional methodologies described in the claims below.

### DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a drawing of an image of a plural component symbology scanned at a first resolution.

FIG. 1B is a drawing of an image of a plural component symbology scanned at a second resolution which is less than the first resolution.

FIG. 2 is a schematic view showing a camera imaging a plurality of containers having plural component symbologies placed thereon.

FIG. 2A is a second schematic view showing a pair of cameras imaging a plurality of containers having plural component symbologies placed thereon.

FIG. 3 is a flow diagram showing a method of reading plural component symbologies as shown in FIG. 1A.

FIGS. 4A, 4B and 4C show additional items which can be included in the flow chart of FIG. 3.

FIG. 5 is a flow diagram showing another method of reading plural component symbologies as shown in FIG. 1A.

### DETAILED DESCRIPTION OF THE INVENTION

The aspects, features and advantages of the present invention will become better understood with regard to the following description with reference to the accompanying drawing(s). What follows are preferred embodiments of the present invention. It should be apparent to those skilled in the art that these embodiments are illustrative only and not limiting, having been presented by way of example only. All the features disclosed in this description may be replaced by alternative features serving the same purpose, and equivalents or similar purpose, unless expressly stated otherwise. Therefore, numerous other embodiments of the modifications thereof are contemplated as falling within the scope of the present invention as defined herein and equivalents thereto.

The detectable element 14 and 16 can, in accordance with this invention, be optically distinguishable from each other in ways other than different resolution. For example, they may have different colors, different reflectivity, different shape or others.

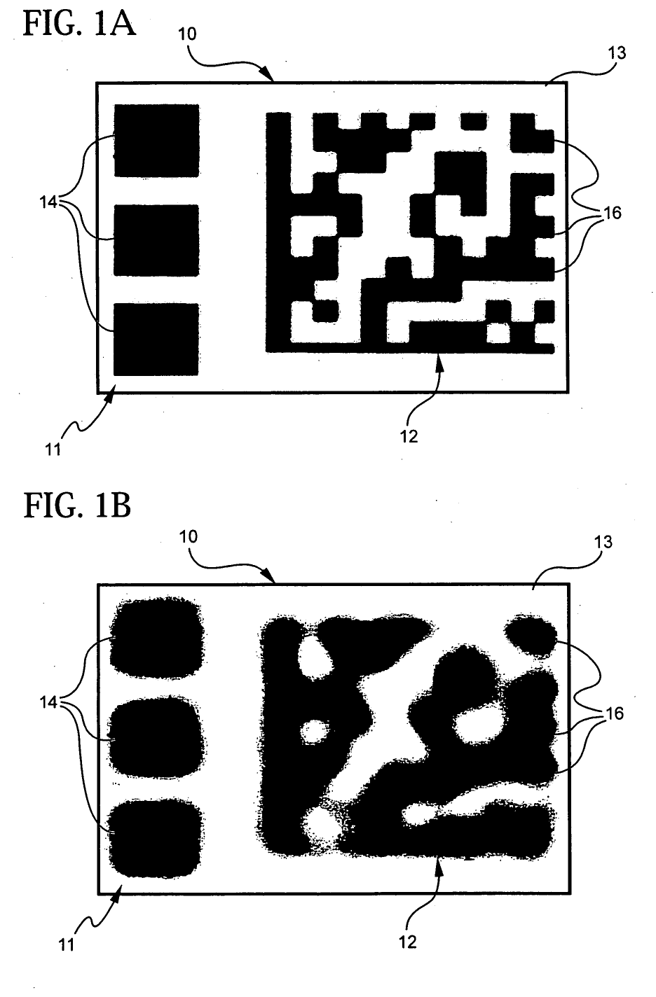

Referring now to FIG. 1A we see an image of a code 10, which is a plural component symbology, scanned at a first resolution. The code 10 includes a locator code symbol 11 and a data code symbol 12 which are displayed on a substrate 13 at a fixed physical relationship to each other. The locator code symbol 11 is made from a plurality of detectable elements 14. The detectable elements 14 are either black or white. The date code symbol 12 is made from a plurality of detectable elements 16. The detectable elements 16 are either black or white. As can be seen the size of the detectable elements 14 are greater than the detectable elements 16 so that the number of pixels resulting from a scan of the detectable elements 14 will be greater than the number of pixels resulting from a scan of the detectable elements 16 no matter what the resolution of the scan is.

Referring now to FIG. 1B we see another image of the code 10, scanned at a second resolution. The second resolution is less than the first resolution. Referring now to FIGS. 1A and 1B together we see that the image in FIG. 1A has well defined edges and that a pattern is recognizable. We also see that the image in FIG. 1B does not have well defined edges and that the image is blurred. We also see that the detectable elements 14 are still recognizable while the detectable elements 16 are not. This is because with any given resolution the number of pixels in the larger detectable elements 14 will be greater than the number of pixels in the smaller detectable elements 16. In FIG. 1B the loss of information due to the reduced resolution and loss of data partially eliminate the inherent detection data in the data matrix code and may prevent the detection of the data matrix. Therefore, the locator code symbol 11 has been added.

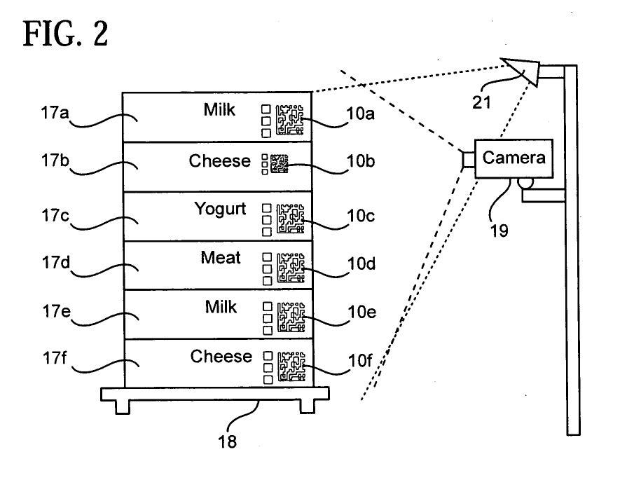

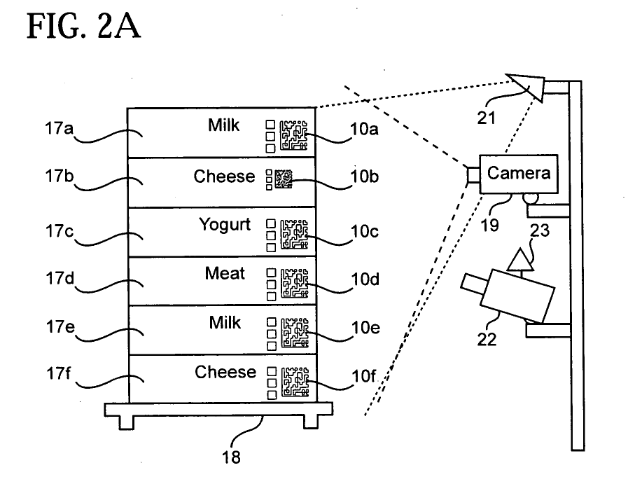

Referring now to FIG. 2 we see a plurality of objects 17a-17f, each of which has a coded marking 10a-10f Of thereon, each of which is a plural-component symbology such as shown in FIG. 1A. The coded markings 10a-10f may be printed on a substrate which is adhered to the object 17a-17f or may be printed directly on the object 17a-17f using the object 17a-17f as a substrate. The plurality of objects 17a-17fare piled on a palate 18 positioned in front of a camera 19 and a lamp 21.

Referring now to FIG. 2A we see the plurality of objects 17a-17f, with the coded marking 10a-10fpiled on the palate 18 positioned in front of the camera 19 and the lamp 21 directed towards the objects 17a-17fon the palate 18. In addition a pan, tilt, zoom camera assembly (PTZ) 22 and a lamp 23 are shown also directed towards the plural-component symbology 10b on object 17b on the palate 18.

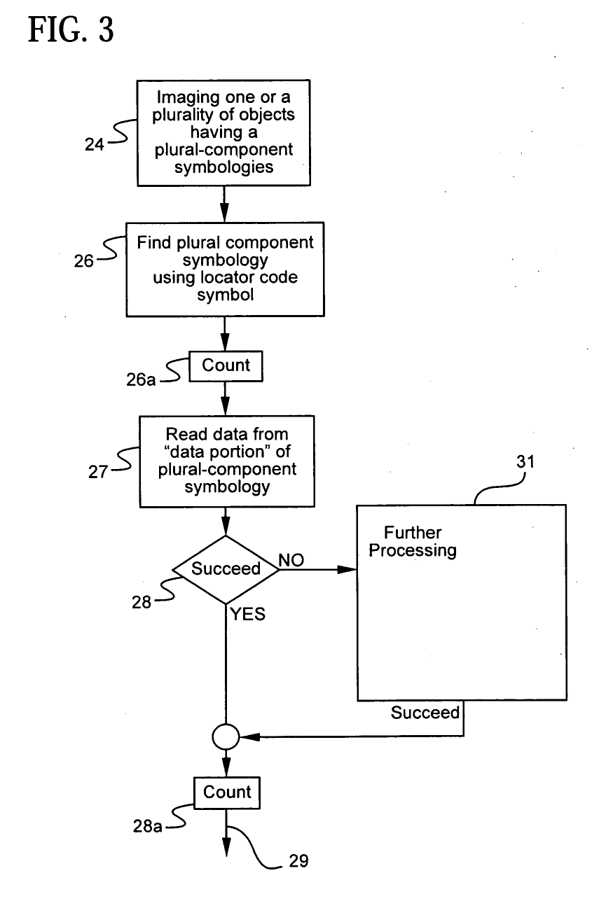

Referring to FIGS. 3-5 we see flow charts for methodologies in accordance with the principles of this invention. In FIG. 3 the first step 24 is imaging one or more of a plurality of objects, at least some of which have a plural component symbology thereon. The imaging step 24 can be done with the equipment shown FIG. 2 or FIG. 2A by camera 19 (or camera 22 if it is adjusted properly). The cameras 19 and 22 provide electronic signals representing an image of the objects 17a-17f.

It should be noted that the coded marking 10b on object 17b is smaller than the other coded markings 10a, 10c-10f and therefore the electronic signals produced by camera 19 or 22 will provide images of lower resolution for coded marking 10b than for the others. In other cases one or more of the codes can be shaded or blurry and so on.

The next step 26 in FIG. 3 is to find the plural component symbologies using the locator code symbol 11 of one of the plural component symbologies at a time. An optional step 26a is to count the number of plural component symbologies found in step 26.

The next step 27 is to read data from the data code symbol 12 of the particular plural component symbology being read. In step 28 it is determined whether the particular plural component symbology has been successfully read or not. If it is successfully read the data is ultimately provided on a lead 29 while the number of plural component symbologies successfully read may be counted at optional step 28a. If the reading is unsuccessful at least the data code portion 12 of the unsuccessful read plural component symbology is passed to the next step which is further processing 31. If step 31 is successful and the further processing results in the successful reading of the data code symbol 12 the read data is combined with the output from step 28 to be optionally counted at step 28a and have the read data provided on line 29.

It should of course be understood that the reason the locator code symbol 11 can be read even in instances where the date code symbol 12 can not is because the locator code symbol 11 of plural component symbology is more easily readable due to the greater pixels per detectable element 14 in relationship to the number of pixels in detectable element 16. Some other differentiating optical characteristic, such as color or reflectivity can also be used to insure that locator code symbols 11 are read.

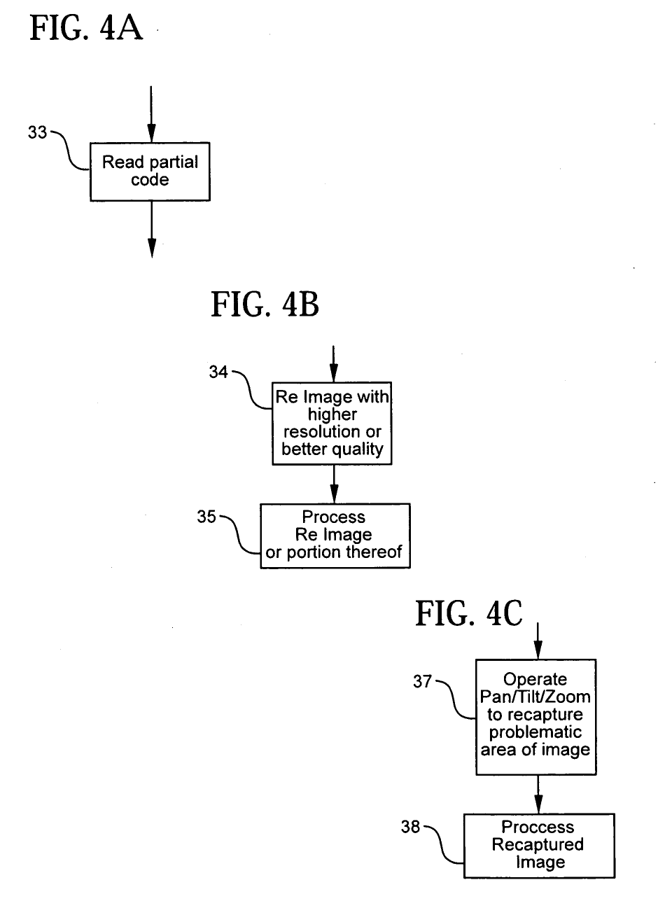

In FIGS. 4A, 4B and 4C there are shown different steps which can be included in the step of further processing 31 in FIG. 3. FIG. 4A adds the further step 32 of reading a partial code 33 which means to read those portions of the data code symbol 12 which are readable and provide the data obtainable to lead 29. A further step can be better and longer processing (which is not normally required).

FIG. 4B adds the sequence of steps of (1) re imaging at higher resolution or better quality 33 and (2) processing the re image or portion thereof at step 34. An example of re imaging at a better quality can include increasing the light available which can be accomplished by turning on the lamp 21 in FIG. 2 or 2A which can eliminate shadows or other things impairing the ability to capture an image with the proper resolution. Imaging at greater resolution can be done by using a second camera with greater resolution or changing the resolution of the camera being used. Processing the re image involves repeating some or all of the steps of FIG. 3.

Processing a portion of a re image or recaptured image is shown in FIG. 4C. Step 37 is to operate a Pan/Tilt/Zoom camera to recapture a problematic area of the original image. This can be done with the equipment in FIG. 2A. Step 38 is reprocessing the recaptured image.

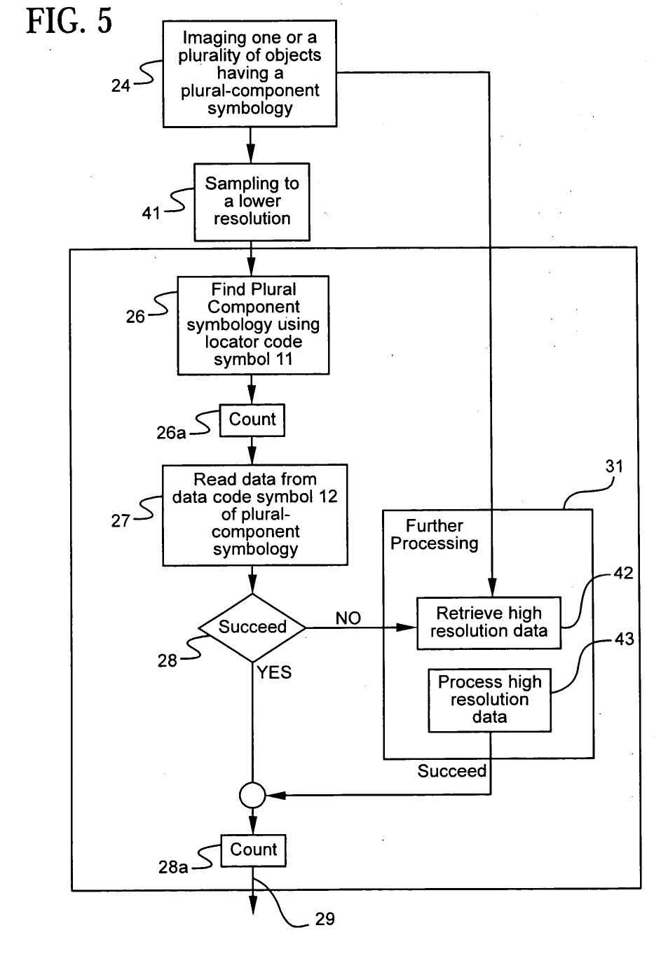

FIG. 5 shows a modified methodology of the methodology of FIG. 3. All steps which are unchanged use the same numbers as in FIG. 3. Referring now to FIG. 5 we see that after step 24 the step 41 is added to sample the signals representing the image to provided signals representing an image of lower resolution than the one represented by the output of step 24. Thus the system operates on a lower resolution that the camera provides. This may be done to reduce processing time or required memory if it is thought that the reduced resolution is sufficient to locate and read all codes 10. There is also shown in further processing steps 42 and 43 which are used if the reduced resolution is not sufficient. Step 42 is to obtain the original presampled higher resolution image data. It can retrieve all the image or part of the image according to the locator coordinates and the size of the date portion. The size of the data portion can be predefined or calculated as a function of the actual size of the locator part in the image and step 43 is to process the higher resolution image data.

While this invention has been described with respect to particular embodiments thereof it should be understood that numerous variations thereof will be obvious to those of ordinary skill in the art in light thereof.

What is claimed is:

1. A plural-component symbology, comprising:
a substrate for displaying symbols thereon;
a locater code symbol displayed on said substrate; said locater code symbol having first detectable elements to be read; and
a data code symbol displayed on said substrate; said data code symbol having second detectable elements to be read; said data code symbol having a fixed physical relationship to said locater code symbol; wherein said first detectable elements are optically distinguishable from said second detectable elements.

2. The plural-component symbology of claim 1 in which said data symbol is a two dimensional bar code symbol.

3. The plural-component symbology of claim 1 in which said data symbol is a Data Matrix bar code symbol.

4. The plural-component symbology of claim 1 in which said wherein said first detectable elements are a different color then said second detectable elements.

5. A plural-component symbology, comprising:
a substrate for displaying visible symbols thereon;
a locater code symbol displayed on said substrate; said locater code symbol having first detectable elements to be read; said first detectable elements having a first size; and
a data code symbol displayed on said substrate; said data code symbol having second detectable elements to be read; said second detectable elements having a second size; said data code symbol having a fixed physical relationship to said locater code symbol; wherein said first size is greater than said second size.

6. The plural-component symbology of claim 5 in which said data symbol is a two dimensional bar code symbol.

7. The plural-component symbology of claim 5 in which said data symbol is a Data Matrix bar code symbol.

8. A methodology for reading data relating to objects comprising:
receiving a plurality of objects, at least some of said plurality of objects having at least one plural-component symbology as defined in claim 1 affixed thereto;
imaging said plurality of objects together to provide an image of said plurality of objects including said plural-component symbologies;
employing said image to locate said at least some of said plurality of objects;
employing said image to attempt to read data relating to all of said at least some of said objects of said plurality of objects; and
if said data is only determined about less than all of said at least some of said plurality of objects further processing some or all of said plural component symbologies.

9. The methodology as defined in claim 8 in which said further processing is counting and indicating the number of said objects of said at least some of said plurality of objects and said data about said less than all of said at least some of said objects of said plurality of objects.

10. The methodology as defined in claim 8 in which said further processing is reading partial data from the unread data.

11. The methodology as defined in claim 8 in which said further processing is re imaging said plurality of objects together to provide a re image of said plurality of objects including said plural-component symbologies; employing said re image to locate said at least some of said plurality of objects; and employing said re image to attempt to read at least the unread data.

12. The methodology as defined in claim 11 in which said re imaging is done with greater resolution.

13. The methodology as defined in claim 11 in which said re imaging is done with better lighting.

14. The methodology as defined in claim 11 in which said re imaging is done with a PTZ camera assembly to capture a select portion of the plurality of objects with greater resolution.

15. The methodology as defined in claim 8 in which said imaging includes the step of obtaining a beginning image in a first resolution and sampling said image in a first resolution to obtain said image; said further processing is obtaining said beginning image; employing said beginning image to locate said at least some of said plurality of objects; and employing said beginning image to attempt to read at least the unread data.

16. A methodology for reading data relating to an object comprising:
receiving an object; said object having at least one plural-component symbology as defined in claim 1 affixed thereto;
imaging said object to provide an image of said object;
employing said image to locate said plural-component symbology;
employing said image to attempt to read data from said plural-component symbology; and
if said data is not read further processing said data symbol of said plural component symbologies.

17. A methodology for reading data relating to objects comprising:
receiving a plurality of objects, at least some of said plurality of objects having at least one plural-component symbology as defined in claim 5 affixed thereto;
imaging said plurality of objects together to provide an image of said plurality of objects including said plural-component symbologies;
employing said image to locate said at least some of said plurality of objects;
employing said image to attempt to read data relating to all of said at least some of said objects of said plurality of objects; and
if said data is only determined about less than all of said at least some of said plurality of objects further processing said data symbols of the unread plural-component symbologies.

18. The methodology as defined in claim 17 in which said further processing is counting and indicating the number of said objects of said at least some of said plurality of objects and said data about said less than all of said at least some of said objects of said plurality of objects.

19. The methodology as defined in claim 17 in which said further processing is reading partial data from the unread data.

20. The methodology as defined in claim 17 in which said further processing is re imaging said plurality of objects together to provide a re image of said plurality of objects including said plural-component symbologies;
employing said re image to locate said at least some of said plurality of objects; and
employing said re image to attempt to read at least the unread data.

21. The methodology as defined in claim 20 in which said re imaging is done with greater resolution.

22. The methodology as defined in claim 20 in which said re imaging is done with better lighting.

23. The methodology as defined in claim 20 in which said re imaging is done with a PTZ camera assembly to capture a select portion of the plurality of objects with greater resolution.

24. The methodology as defined in claim 17 in which said imaging includes the step of obtaining a beginning image in a first resolution and sampling said image in a first resolution to obtain said image; said further processing is obtaining said beginning image;
employing said beginning image to locate said at least some of said plurality of objects; and
employing said beginning image to attempt to read at least the unread data.

25. A methodology for reading data relating to an object comprising:
receiving an object; said object having at least one plural-component symbology as defined in claim 5 affixed thereto;
imaging said object to provide an image of said object employing said image to locate said plural-component symbology;
employing said image to attempt to read data from said plural component symbology; and
if said data is not read further processing said data symbol of said plural-component symbologies.
